(19) United States
(12) Patent Application Publication
(10) Pub. No.: US 2008/0212658 A1
(43) Pub. Date: Sep. 4, 2008

(54) METHOD AND SYSTEM FOR COMMUNICATION OF SIGNALS USING A DIRECT DIGITAL FREQUENCY SYNTHESIZER (DDFS)

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/680,864

(22) Filed: Mar. 1, 2007

(51) Int. Cl. H04L 5/16

(52) U.S. Cl. 375/219

(57) ABSTRACT

Aspects of a method and system for communication of signals using a direct digital frequency synthesizer (DDFS) are provided. A DDFS may enable generation of signals for down converting and/or up converting radio frequency (RF) signals in reception and transmission operations respectively. The DDFS may utilize a clock signal generated by a PLL and at least one frequency control word generated by a processor. The DDFS may generate the same frequency or different frequencies for the down converting signal and for the up converting signal. When different signals are needed for transmission and reception of RF signals, a first DDFS may be utilized for generating signals for down conversion and a second DDFS may be utilized for generating signals for up conversion. In this regard, a processor may generate separate frequency control words for the first DDFS and for the second DDFS.

### CROSS-REFERENCE TO RELATED APPLICATIONS/INCORPORATION BY REFERENCE

Not Applicable.

### FIELD OF THE INVENTION

Certain embodiments of the invention relate to processing of signals for wireless communication. More specifically, certain embodiments of the invention relate to a method and system for communication of signals using a direct digital frequency synthesizer (DDFS).

### BACKGROUND OF THE INVENTION

The widespread deployment of novel features, more advanced applications, and the support of multiple communication protocols in wireless handset devices remains limited by, among other things, increased power consumption, increased size, increased complexity, and increased cost. In this regard, when multiple communication protocols are supported, for example, the need to support a wide range of frequency bands via an RF chain may become difficult to implement. For example, each RF receive chain may comprise a tuner/filter, a down-converter, and an analog-to-digital converter (ADC). Each RF transmit chain may comprise at least one oscillator, a modulator, and an amplifier. When the number of communication protocols and their corresponding frequency bands supported increases, the size, complexity, power consumption, and overall cost may also increase.

Traditionally, the RF transmitter and/or RF receiver have generated the multitude of frequencies needed to support multiple protocols through the use of voltage controlled oscillators (VCO) and phase locked loops (PLL). One drawback of using VCO and PLL for frequency generation is that these circuits have a relatively narrow range of operating frequencies. The narrow range of operation often results in the need for many VCO and/or PLL in a single receiver or transmitter.

Another approach has been to utilize fractional-N PLL frequency synthesizers to try to meet simultaneous fine resolution and high bandwidth. The fractional-N PLL frequency synthesizer enables dithering a divide value between integer values in order to produce a fractional divide value that is utilized in the frequency synthesizer's feedback loop. However, the dithering operation may generally introduce quantization noise into the frequency synthesizer, negatively impacting the overall phase noise performance. Moreover, as the bandwidth in the loop increases more quantization noise appears at the output. However, a higher bandwidth may better suppress the noise contributed by a voltage controlled oscillator (VCO). When trying to achieve a given noise specification, different noise sources inside the PLL may result in conflicting requirements on loop bandwidth.

Implementing novel designs that efficiently enable the generation of high resolution and high bandwidth signals for the transmission and reception of RF signals may allow further deployment of novel features, more advanced applications, and the support of multiple communication protocols in wireless devices.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for communication of signals using a direct digital frequency synthesizer (DDFS), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary wireless terminal, in accordance with an embodiment of the invention.

FIG. 1B is a block diagram illustrating an exemplary RF receiver in a mobile terminal, in accordance with an embodiment of the invention.

FIG. 2A is a block diagram illustrating an exemplary transceiver operation utilizing a single DDFS, in accordance with an embodiment of the invention.

FIG. 2B is a block diagram illustrating an exemplary transceiver operation utilizing a DDFS for transmission of RF signals and a DDFS for reception of RF signals, in accordance with an embodiment of the invention.

FIG. 3 is a block diagram illustrating an exemplary DDFS, in connection with an embodiment of the invention.

FIG. 4 is a flow diagram illustrating exemplary steps for transmission and/or reception of RF signals based on at least one DDFS, in accordance with an embodiment of the invention.

### DETAILED DESCRIPTION OF THE INVENTION

Certain embodiments of the invention may be found in a method and system for communication of signals using a direct digital frequency synthesizer (DDFS). Aspects of the invention may comprise a DDFS that may enable generation of signals for down converting and/or up converting radio frequency (RF) signals in reception and transmission operations respectively. The DDFS may utilize a clock signal generated by a PLL and at least one frequency control word generated by a processor. The DDFS may generate the same frequency or different frequencies for the down converting signal and for the up converting signal. When different signals are needed for transmission and reception of RF signals, a first DDFS may be utilized for generating signals for down conversion and a second DDFS may be utilized for generating signals for up conversion. In this regard, a processor may generate separate frequency control words for the first DDFS and for the second DDFS.

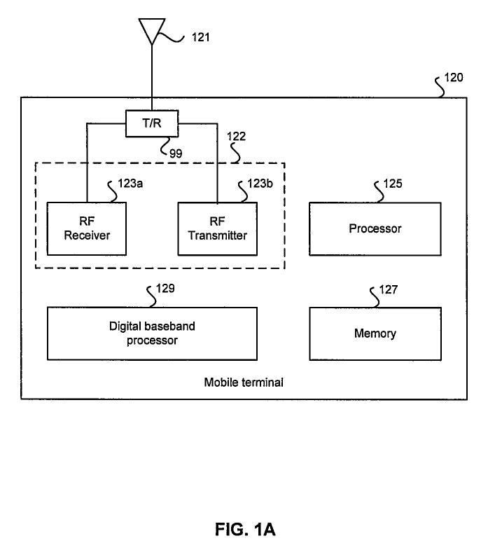

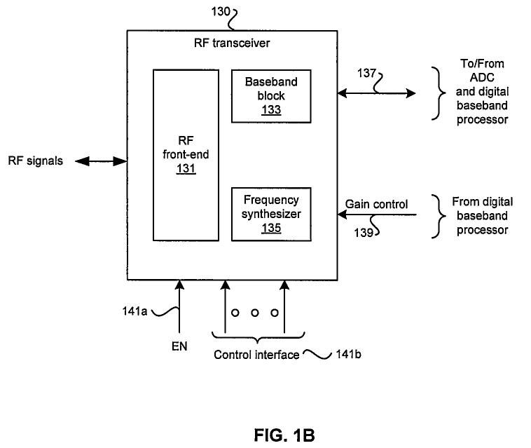

FIG. 1A is a block diagram illustrating an exemplary wireless terminal, in accordance with an embodiment of the invention. Referring to FIG. 1A, there is shown a wireless terminal 120 that may comprise an RF receiver 123a, an RF transmitter 123b, a digital baseband processor 129, a processor 125, and a memory 127. In an embodiment of the invention, the RF receiver 123a and the RF transmitter 123b may be integrated into a single RF transceiver 122, for example. A single transmit and receive antenna 121 may be communicatively coupled to the RF receiver 123a and the RF transmitter 123b. In some instances, a switch, such as the T/R switch 99 or other device having switching capabilities, may be coupled between the RF receiver 123a and RF transmitter 123b, and may be utilized to switch the antenna between transmit and receive functions. The wireless terminal 120 may be operated in a system, such as a Wireless Local Area Network (WLAN), a cellular network and/or digital video broadcast network, for example. In this regard, the wireless terminal 120 may support a plurality of wireless communication protocols, including the IEEE 802.11n standard specifications for WLAN networks. The wireless terminal 120 may also support a plurality of cellular protocols such as GSM/EDGE and/or WCDMA. Moreover, the wireless terminal 120 may support Bluetooth operations, for example.

The RF receiver 123a may comprise suitable logic, circuitry, and/or code that may enable processing of received RF signals. The RF receiver 123a may enable receiving of RF signals in a plurality of frequency bands in accordance with the wireless communications protocols that may be supported by the wireless terminal 120. Each frequency band supported by the RF receiver 123a may have a corresponding front-end circuit for handling low noise amplification and down conversion operations, for example. In this regard, a front-end circuit may enable support of a wide range of frequencies. The RF receiver 123a may be referred to as a multi-band receiver when it supports more than one frequency band. In another embodiment of the invention, the wireless terminal 120 may comprise more than one RF receiver 123a, wherein each of the RF receiver 123a may be a single-band or a multi-band receiver. The RF receiver 123a may be implemented on a chip. In an embodiment of the invention, the RF receiver 123a may be integrated with the RF transmitter 123b on a chip to comprise an RF transceiver, for example. In another embodiment of the invention, the RF receiver 123a may be integrated on a chip with more than one component in the wireless terminal 120.

The RF receiver 123a may quadrature down convert the received RF signal to a baseband frequency signal that comprises an in-phase (I) component and a quadrature (Q) component. The RF receiver 123a may also support polar modulation operations. In this regard, the RF receiver 123a may receive a local oscillator or reference signal from the wireless terminal 120 to perform the down conversion of received RF signals. The RF receiver 123a may perform direct down conversion of the received RF signal to a baseband frequency signal, for example. In some instances, the RF receiver 123a may enable analog-to-digital conversion of the baseband signal components before transferring the components to the digital baseband processor 129. In other instances, the RF receiver 123a may transfer the baseband signal components in analog form.

The digital baseband processor 129 may comprise suitable logic, circuitry, and/or code that may enable processing and/or handling of baseband frequency signals. In this regard, the digital baseband processor 129 may process or handle signals received from the RF receiver 123a and/or signals to be transferred to the RF transmitter 123b, when the RF transmitter 123b is present, for transmission to the network. The digital baseband processor 129 may also provide control and/or feedback information to the RF receiver 123a and/or to the RF transmitter 123b based on information from the processed signals. The digital baseband processor 129 may also provide digital control words for generating the appropriate local oscillator or reference signals to be utilized by the RF receiver 123a and/or the RF transmitter 123b. The digital baseband processor 129 may communicate information and/or data from the processed signals to the processor 125 and/or to the memory 127. Moreover, the digital baseband processor 129 may receive information from the processor 125 and/or to the memory 127, which may be processed and transferred to the RF transmitter 123b for transmission to the network. In an embodiment of the invention, the digital baseband processor 129 may be integrated on a chip with more than one component in the wireless terminal 120.

The RF transmitter 123b may comprise suitable logic, circuitry, and/or code that may enable processing of RF signals for transmission. The RF transmitter 123b may enable transmission of RF signals in a plurality of frequency bands. Each frequency band supported by the RF transmitter 123b may have a corresponding front-end circuit for handling amplification and up conversion operations, for example. In this regard, a front-end circuit may enable support of a wide range of frequencies. The RF transmitter 123b may be referred to as a multi-band transmitter when it supports more than one frequency band. In another embodiment of the invention, the wireless terminal 120 may comprise more than one RF transmitter 123b, wherein each of the RF transmitter 123b may be a single-band or a multi-band transmitter. The RF transmitter 123b may be implemented on a chip. In an embodiment of the invention, the RF transmitter 123b may be integrated with the RF receiver 123a on a chip to comprise an RF transceiver, for example. In another embodiment of the invention, the RF transmitter 123b may be integrated on a chip with more than one component in the wireless terminal 120.

The RF transmitter 123b may quadrature up convert the baseband frequency signal comprising I/Q components to an RF signal. The RF transmitter 123b may also support polar modulation operations. In this regard, the RF transmitter 123b may receive a local oscillator or reference signal from the wireless terminal 120 to perform the up conversion of baseband signals for RF transmission. The RF transmitter 123b may perform direct up conversion of the baseband frequency signal to an RF frequency signal, for example. In some instances, the RF transmitter 123b may enable digital-to-analog conversion of the baseband signal components received from the digital baseband processor 129 before up conversion. In this regard, the RF transmitter 123b may comprise one or more circuits such as, for example, a digital-to-analog converter (DAC) that enables digital-to-analog conversion of the baseband signal components received from the digital baseband processor 129. In other instances, the RF transmitter 123b may receive baseband signal components in analog form.

The processor 125 may comprise suitable logic, circuitry, and/or code that may enable control and/or data processing operations for the wireless terminal 120. The processor 125 may be utilized to control at least a portion of the RF receiver 123a, the RF transmitter 123b, the digital baseband processor 129, and/or the memory 127. In this regard, the processor 125 may generate at least one signal for controlling operations within the wireless terminal 120. For example, the processor 125 may provide digital control words for generating the appropriate local oscillator or reference signals to be utilized by the RF receiver 123a and/or the RF transmitter 123b. The processor 125 may also enable executing of applications that may be utilized by the wireless terminal 120. For example, the processor 125 may generate at least one control signal and/or may execute applications that may enable current and proposed WLAN communications in the wireless terminal 120.

The memory 127 may comprise suitable logic, circuitry, and/or code that may enable storage of data and/or other information utilized by the wireless terminal 120. For example, the memory 127 may be utilized for storing processed data generated by the digital baseband processor 129 and/or the processor 125. The memory 127 may also be utilized to store information, such as configuration information, that may be utilized to control the operation of at least one block in the wireless terminal 120. For example, the memory 127 may comprise information necessary to configure the RF receiver 123a for receiving signals in the appropriate frequency band and/or to configure the RF transmitter 123b for transmitting signals in the appropriate frequency band. In this regard, the memory 127 may store information regarding the generation of control words utilized within the wireless terminal 120 to generate the appropriate up conversion and down conversion signals.

FIG. 1B is a block diagram illustrating an exemplary RF transceiver in a mobile terminal, in accordance with an embodiment of the invention. Referring to FIG. 1B, there is shown an RF transceiver 130 that may comprise an RF front-end 131, a baseband block 133, and a frequency generator 135. The RF transceiver 130 may correspond to the RF receiver 123a and the RF transmitter 123b in the wireless terminal 120 disclosed in FIG. 1A, for example.

The RF transceiver 130 may comprise suitable logic, circuitry, and/or code that may enable handling of a plurality of RF signals that may comprise signals in accordance with the IEEE 802.11n standard specifications for WLAN networks, cellular signals, and/or Bluetooth signals for example. The RF transceiver 130 may be enabled via an enable signal, such as the signal EN 141a, for example. At least a portion of the circuitry within the RF transceiver 130 may be controlled via the control interface 141b. The control interface 141b may receive information from, for example, a processor, such as the processor 125 and/or the digital baseband processor 129 disclosed in FIG. 1A. The control interface 141b may comprise more than one bit. For example, when implemented as a 2-bit interface, the control interface 139b may be an inter-integrated circuit (I2C) interface. The control interface 141b may enable controlling the generation of a local oscillator or reference signal that may be utilized by the RF front-end 131 for up conversion of baseband signals for transmission and/or down conversion of received RF signals to baseband signals.

The RF front-end 131 may comprise suitable logic, circuitry, and/or code that may enable processing of baseband signals for up conversion to RF signals for transmission. The RF front-end 131 may also enable processing of received RF signals for down conversion to baseband signals. The RF front-end 131 may communicate the resulting baseband frequency signals to the baseband block 133 for further processing. Similarly, the RF front-end 131 may receive baseband signals from the baseband block 133 for further processing. In an embodiment of the invention, the RF front-end 131 may enable receiving RF signals in a plurality of frequency bands that may comprise the frequency bands utilized for WLAN communications, cellular communications, and/or Bluetooth communication. In this regard, the RF front-end 131 may be implemented by utilizing separate RF front-end blocks for each of the frequency bands supported, for example. The RF front-end 131 may enable transmitting RF signals in a plurality of frequency bands that may comprise the frequency bands utilized for WLAN communications, cellular communications, and/or Bluetooth communication. In this regard, the RF front-end 131 may be implemented by utilizing separate RF front-end blocks for each of the frequency bands supported, for example.

The frequency synthesizer 135 may comprise suitable logic, circuitry, and/or code that may enable generating the appropriate local oscillator (LO) signal or reference signal for performing down conversion and/or up conversion in the RF front-end 131. The frequency synthesizer 135 may be based on at least one direct digital frequency synthesizer (DDFS) for generating the appropriate up conversion and down conversion reference signals. Improvements in CMOS process technology may enable the implementation of at least one DDFS into a chip that may be utilized within the RF transceiver 130. In some instances, the frequency synthesizer 135 may generate signals for up conversion that may differ in frequency from signals generated for down conversion in accordance with the requirements of a particular communication protocol. The DDFS 135 may be fabricated utilizing a deep submicron process such as a 45 nanometer (nm) deep submicron process. The 45 nanometer (nm) deep submicron process may be a 45 nanometer (nm) deep submicron CMOS process. In this regard, the DDFS 135 may be enabled to generate high frequency signals that may facilitate polar modulation.

When a communication protocol operates in a time-division multiplexing scheme, that is, transmission and reception of signals occur at different times or timeslots, then the frequency synthesizer 135 may utilize a single DDFS to generate the appropriate signals. This may occur when the wireless terminal 120 operates in WLAN, GSM/EDGE, and/or Bluetooth applications, for example. When a communication protocol enables simultaneous transmission and reception of signals, then the frequency synthesizer 135 may utilize a first DDFS to generate signals for up converting baseband signals and a second DDFS to generate signals for down converting received RF signals. This may occur when the wireless terminal 120 operates in WCDMA applications, for example.

The baseband block 133 may comprise suitable logic, circuitry, and/or code that may enable processing of baseband signals generated from the down conversion operations in the RF front-end 131. The baseband block 133 may also enable processing of baseband signals for transmission via the RF front-end 131. The baseband block 133 may enable processing of I/Q components in analog form, for example. The baseband block 133 may also enable communication of baseband signals via signal 137, for example, with an analog-to-digital converter (ADC) and the digital baseband processor 129. The baseband block 133 may also be utilized to support processing in polar modulation applications. In this regard, the components communicated with the ADC and the digital baseband processor 129 may be phase and amplitude components, for example.

The RF transceiver 130 may enable receiving at least one signal, such as the gain control signal 139, from the digital baseband processor 129 for adjusting operations of the RF transceiver 130. For example, the gain control signal 139 may be utilized to adjust the gain provided by the baseband block 133 on the baseband frequency signals generated from the RF front-end 131. In another example, the gain control signal 139 may be utilized to adjust the gain provided by low-noise amplifiers (LNAs) and/or power amplifiers (PAs) in the RF front-end 131. In this regard, the signal gain control signal 139 may be utilized to adjust gains during a calibration mode, for example. In another example, the RF transceiver 130 may enable receiving from the digital baseband processor 129 at least one control signal or control information via the control interface 141b for adjusting operations within the RF transceiver 130.

Notwithstanding the RF transceiver 130 as described in FIG. 1B, aspects of the invention need not be so limited. For example, in some instances, a frequency synthesizer may be integrated within an RF transmitter and may be utilized by an RF receiver. In other instances, a frequency synthesizer may be integrated within an RF receiver and may be utilized by an RF transmitter.

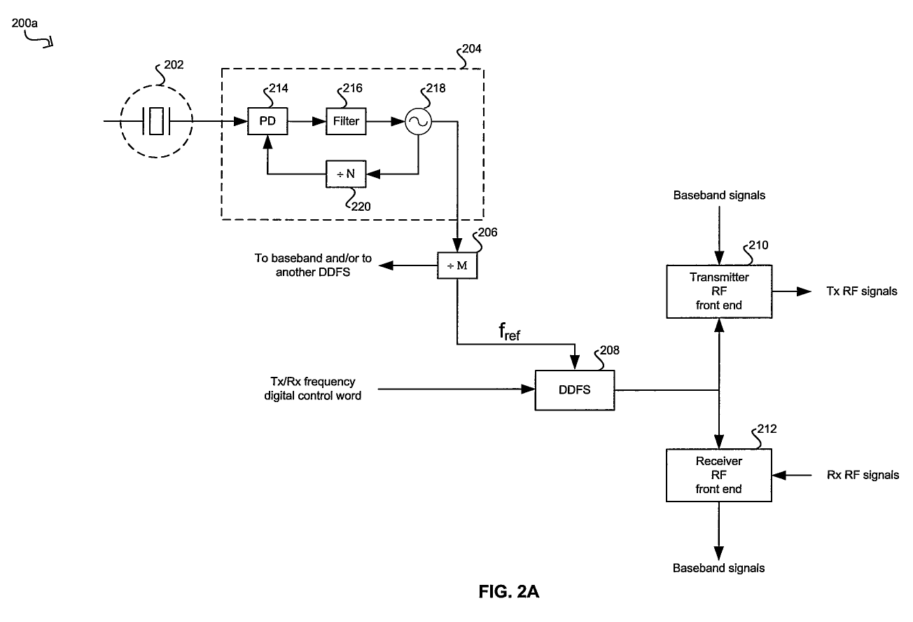

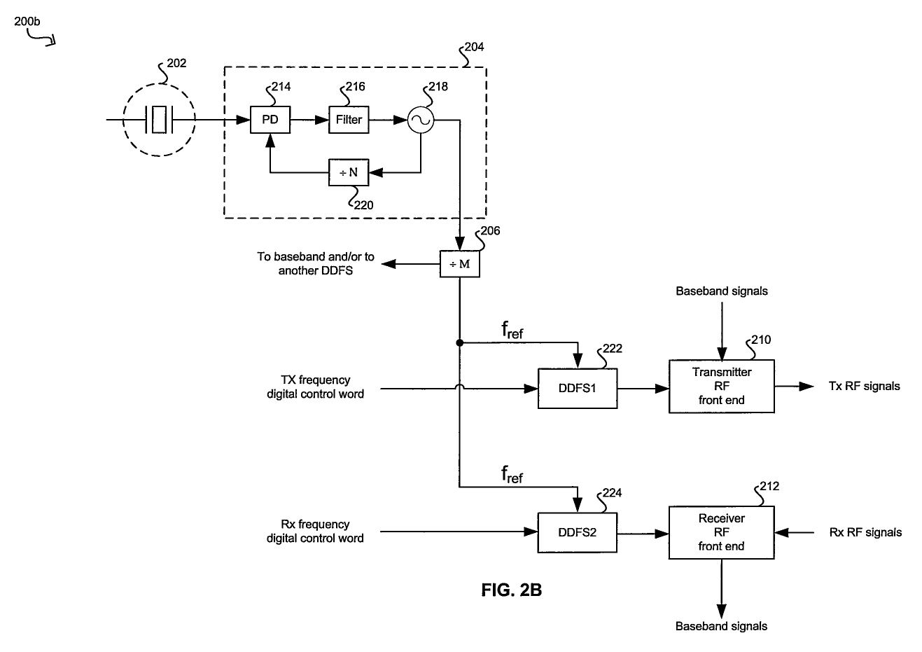

FIG. 2A is a block diagram illustrating an exemplary transceiver operation utilizing a single DDFS, in accordance with an embodiment of the invention. Referring to FIG. 2, there is shown a portion 200a of a transceiver that may correspond to the generation of local oscillator or reference signals for performing up conversion operations for RF signal transmission and/or down conversion operations for RF signal reception. There is shown a crystal (Xtal) oscillator 202, a phase-locked-loop (PLL) 204, a frequency divider 206, a DDFS 208, a transmitter RF front-end 210, and a receiver RF front-end 212. The PLL 204 may comprise a phase detector (PD) 214, a filter 216, a voltage-controlled oscillator 218, and a frequency divider 220.

The PD 214 may comprise suitable logic, circuitry, and/or code that may enable performing phase difference detection between the signal from the Xtal oscillator 202 and the signal being fed back via the divider 220. The output of the PD 214 may be communicated to the filter 216. The filter 216 may comprise suitable logic, circuitry, and/or code that may enable filtering the output of the PD 214 to control the operation of the VCO 218. The VCO 218 may comprise suitable logic, circuitry, and/or code that may enable generation of an output reference signal based on the filtered output generated by the filter 216. The VCO 218 may utilize a programmable conversion factor (K_{VCO}) for determining the output reference signal frequency in accordance with the voltage level of the output of the filter 216. In this regard, the K_{VCO} may be programmable in accordance with the frequency of the VCO 218. The reference signal generated by the VCO 218 may be communicated to the frequency divider 220 and to the frequency divider 206, for example. The frequency divider 220 may comprise suitable logic, circuitry, and/or code that may enable dividing the frequency of the output of the VCO 218 by a factor (N) in order to feed it back to the PD 214. The frequency divider 220 may be implemented as a multi-modulus divider (MMD) for example.

In one embodiment of the invention, the PLL 204 may operate with a plurality of crystal frequencies in order to enable the DDFS 208 to generate the appropriate up conversion and down conversion signals for a corresponding wireless communication protocol operation. In this regard, the PLL 204 may enable generation of an appropriate output reference signal based on the input from the Xtal oscillator 202 to be communicated to the DDFS 208. In other instances, the PLL 204 may enable generation of an appropriate output reference signal based from frequencies provided from another portion of the transceiver or from a portion or component from the wireless terminal 120 disclosed in FIG. 1A.

In one embodiment of the invention, the PLL 204 may be designed to provide high frequency reference signals with frequencies between approximately 15 GHz and 60 GHz, for example. In this regard, the PLL 204 may be utilized to provide a reference signal or reference clock that may be utilized by the DDFS 208 to support a plurality of communication protocols, such as WLAN, GSM/EDGE, WCDMA, and/or Bluetooth, for example.

The frequency divider 206 may comprise suitable logic, circuitry, and/or code that may enable dividing the frequency of the output of the VCO 218 by a factor (M) in order to provide the reference signal (f_{ref}) to the DDFS 208. The frequency divider 206 may be implemented as an MMD, for example. The frequency divider 206 may be utilized to generate reference signals for baseband operations and/or to generate reference signals for use by at least one more DDFS. For baseband operations, the frequency divider 206 may be utilized to generate a 500 MHz reference signal from the output generated by the PLL 204, for example.

The DDFS 208 may comprise suitable logic, circuitry, and/or code that may enable generation of a signal to be utilized by the transmitter RF front-end 210 for up converting baseband signals to RF signals for transmission. Similarly, the DDFS 208 may enable generation of a signal to be utilized by the receiver RF front-end 212 for down converting received RF signals to baseband signals. The DDFS 208 may utilize a reference signal, f_{ref}, which may be received from the frequency divider 206. In some instances, the reference signal, f_{ref}, may be received directly from the PLL 204, for example. The DDFS 208 may also utilize a transmit and/or a receive frequency digital control word that may enable determine the appropriate up conversion and/or down conversion signal frequency. In this regard, the frequency digital control words may be received from, for example, the digital baseband processor 129 and/or the processor 120 disclosed in FIG. 1A. Moreover, the frequency digital control words may be received in a transceiver via an interface, such as the control interface 141b disclosed in FIG. 1B, for example.

The DDFS 208 may generate up converted signals and/or down converted signals of the same frequency or of different frequencies in accordance with the communication protocol being supported. When different upconverted signal frequencies and/or down converted signal frequencies are needed, the DDFS 208 may support communication protocols in which transmission and reception of RF signals need not be performed at the same time.

The transmitter RF front-end 210 may comprise suitable logic, circuitry, and/or code that may enable processing of baseband signals for transmission over a wireless medium. In this regard, the transmitter RF front-end 210 may enable modulation or up conversion, filtering, and/or amplification of baseband signals for RF transmission. For modulation and/or up conversion, the transmitter RF front-end 210 may utilize the output signal generated by the DDFS 208, for example. The transmitter RF front-end 210 may process baseband signals communicated from the digital baseband processor 129 via the baseband block 133 disclosed in FIG. 1B, for example.

The receiver RF front-end 212 may comprise suitable logic, circuitry, and/or code that may enable processing of RF signals received from a wireless medium. In this regard, the receiver RF front-end 212 may enable demodulation or down conversion, filtering, and/or amplification of received RF signals. For demodulation or down conversion, the receiver RF front-end 212 may utilize the output signal generated by the DDFS 208, for example. The processed baseband signals that result from the operations of the receiver RF front-end 212 may be communicated to the digital baseband processor 129 via the baseband block 133 disclosed in FIG. 1B, for example.

FIG. 2B is a block diagram illustrating an exemplary transceiver operation utilizing a DDFS for transmission of RF signals and a DDFS for reception of RF signals, in accordance with an embodiment of the invention. Referring to FIG. 2B, there is shown a portion 200b of a transceiver that is substantially similar to the portion 200a disclosed in FIG. 2A. However, the portion 200b discloses a first DDFS (DDFS1) 222 and a second DDFS (DDFS2) 224 instead of a single DDFS 208 as disclosed in FIG. 2A.

The DDFS1 222 and the DDFS2 224 may be the same or substantially similar to the DDFS 208 disclosed in FIG. 2A. The DDFS1 222 may be utilized to generate the up conversion signals utilized by the transmitter RF front-end 210 while the DDFS2 224 may be utilized to generate the down conversion signals utilized by the receiver RF front-end 212. The DDFS1 222 and the DDFS2 224 may receive a reference signal, f_{ref}, which may be received from the frequency divider 206, for example. The DDFS1 222 may receive a transmit frequency digital control word that may enable determine the appropriate up conversion signal frequency, while the DDFS2 224 may receive a receive frequency digital control word that may enable determine the appropriate down conversion signal frequency. In this regard, the frequency digital control words may be received from, for example, the digital baseband processor 129 and/or the processor 120 disclosed in FIG. 1A. When different up conversion and/or down conversion frequencies are needed, utilizing separate DDFSs for up conversion and down conversion may enable support of communication protocols in which transmission and reception of RF signals are performed simultaneously.

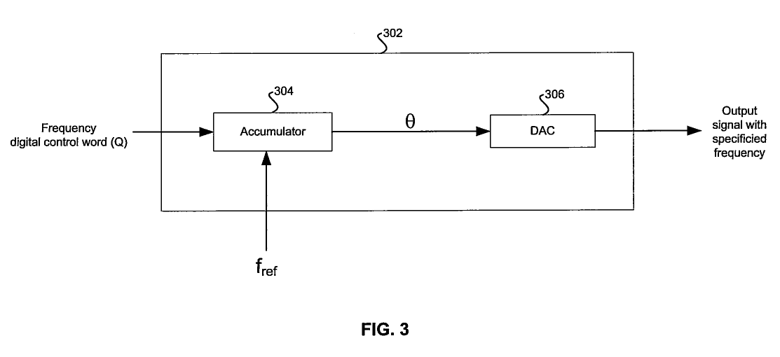

FIG. 3 is a block diagram illustrating an exemplary DDFS, in connection with an embodiment of the invention. Referring to FIG. 3, there is shown a DDFS block 302 that may comprise an accumulator 304 and a digital-to-analog-converter (DAC) 306.

The accumulator 302 may comprise suitable logic, circuitry, and/or code that may enable successively adding a frequency digital control word, Q, to a value stored in the accumulator on each cycle of a reference clock. The accumulator may receive the frequency digital control word, Q, from a processor, such as the digital baseband processor 129 and/or the processor 125 disclosed in FIG. 1A. The accumulator 302 may also receive a reference signal, f_{ref}, from, for example, a phase-locked loop such as the PLL 204 in FIG. 2A. In this regard, the frequency digital control word, Q, and the reference signal, f_{ref}, may determine a phase and/or a frequency of the output signal of the DDFS 302.

The DAC 306 may comprise suitable logic, circuitry, and and/or code that may enable generation of an analog output signal from a digital input signal from the accumulator 302, wherein the analog output signal may be of varying phase, frequency, and/or amplitude. In one embodiment of the invention, the DAC 306 may utilize a number of lookup tables used to generate the analog output signals.

In operation, the DDFS 302 may be a digitally-controlled signal generator that may vary a phase, a frequency, and/or an amplitude of one or more output signals based on a single fixed-frequency reference signal, f_{ref}, and a frequency digital control word, Q. The frequency digital control word may be provided to the accumulator 302, and may be successively added to a value stored in the accumulator on each cycle of the reference clock. In this manner, the sum will eventually be greater than the maximum value the accumulator may store, and the value in the accumulator may overflow or “wrap”. Accordingly, an N-bit accumulator will overflow at a frequency fₒ given by the following expression:

fₒ=f_{ref}(Q/2^{N}),

where Q is the value of the frequency digital control word, N is the number of bits of the accumulator 304, and f_{ref} is the reference signal that results from the operations of the PLL 204 and/or the frequency divider 206. As a result, the output of the accumulator, θ, may be periodic with period of 1/fₒ. Providing the output of the accumulator 304 to the DAC 306 may then enable the generation of one or more signals of varying phase, frequency, and/or amplitude. In this regard, the DDFS 302 may be well suited as a frequency generator that generates one or more sine waves or other periodic waveforms over a large range of frequencies, from almost DC to approximately half the reference frequency, f_{ref}.

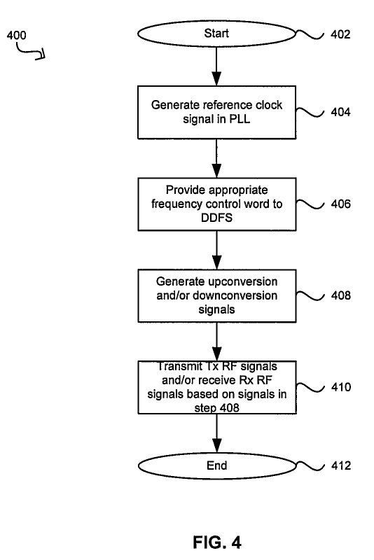

FIG. 4 is a flow diagram illustrating exemplary steps for transmission and/or reception of RF signals based on at least one DDFS, in accordance with an embodiment of the invention. Referring to FIG. 4, there is shown a flow diagram 400. In step 404, after start step 402, the PLL 204 disclosed in FIG. 2 may be utilized to generate a reference signal or reference clock based on the Xtal oscillator 202. The reference signal generated by the PLL 204 may be communicated to the frequency divider 206 where it may be frequency divided to a new frequency value.

In step 406, the digital baseband processor 129 and/or the processor 125 disclosed in FIG. 1A may be utilized to generate appropriate frequency digital control words that may be communicated to a DDFS, such as the DDFS 302 disclosed in FIG. 3, for example, to generate the corresponding local oscillator or reference signal for RF transmission and/or reception. For example, in instances when the single DDFS 208 as disclosed in FIG. 2A may be used for transmission and reception, the frequency digital control words may be generated and communicated to the DDFS 208 in a manner that enables generating the up conversion signal to the transmitter RF front-end 210 and the down conversion signal to the receiver RF front-end 212 in accordance with the communication protocol being supported. In this regard, a single DDFS may be sufficient for applications where the same frequency is utilized for up conversion and down conversion and/or for applications where different frequencies are utilized but transmission and reception need not occur simultaneously.

When separate DDFSs are utilized, such as the use of DDFS1 222 and DDFS2 224 as disclosed in FIG. 2B, for transmission and reception, the frequency digital control words may be generated and communicated to the DDFS1 222 and DDFS2 224 in a manner that enables generating the up conversion signal from the DDFS1 222 to the transmitter RF front-end 210 and the down conversion signal from the DDFS2 224 to the receiver RF front-end 212 in accordance with the communication protocol being supported. In this regard, separate DDFSs may be utilized in applications where different frequencies are utilized and transmission and reception occurs simultaneously.

In step 408, the up conversion signals and/or down conversion signals may be generated based on the frequency digital control words and the reference signals, f_{ref}, generated from the PLL 204. In step 410, the transmitter RF front-end 210 may utilize the up conversion signals generated in step 408 to process baseband signals for RF transmission over a wireless medium. Similarly, the receiver RF front-end 212 may utilize the down conversion signals generated in step 408 to process and convert the received RF signals to baseband signals which may be further processed by the baseband block 133 in FIG. 1B and/or the digital baseband processor 129. After step 410, the process may proceed to end step 412.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising: generating at least one signal via at least one direct digital frequency synthesizer (DDFS) based on a clock signal generated by a PLL and one or more frequency control word, wherein said generated at least one signal is utilized for one or more of: down converting radio frequency signals received via a receiver, and up converting signals to radio frequencies for transmission via a transmitter.

2. The method according to claim 1, comprising generating said at least one frequency control word for said at least one DDFS by a processor.

3. The method according to claim 1, comprising generating said at least one signal with a first frequency value for said down converting of said radio frequency signals received via said receiver.

4. The method according to claim 1, comprising generating said at least one signal with a second frequency value for said up converting of signals to said radio frequencies for transmission via said transmitter.

5. The method according to claim 1, comprising generating said at least one signal with a same frequency value for said down converting of said radio frequency signals received via said receiver and for said up converting of signals to said radio frequencies for transmission via said transmitter.

6. The method according to claim 1, comprising generating in a first DDFS, said at least one signal for said down converting of said radio frequency signals received via said receiver.

7. The method according to claim 6, comprising generating said at least one frequency control word for said first DDFS in a processor.

8. The method according to claim 1, comprising generating in a second DDFS said at least one signal for said up converting of signals to said radio frequencies for transmission via said transmitter.

9. The method according to claim 8, comprising generating said at least one frequency control word for said second DDFS in a processor.

10. The method according to claim 1, comprising adjusting said at least one frequency control word based on a communication protocol.

11. A system for processing wireless communication signals, the system comprising:
one or more circuits in a transmitter or a receiver, said one or more circuits comprising at least one direct digital frequency synthesizer (DDFS), a PLL, and a processor, wherein:
said at least one DDFS generates at least one signal based on one or more frequency control words and a clock signal generated by said PLL, and
said generated at least one signal is utilized for one or more of: down converting radio frequency signals received via said receiver, and up converting signals to radio frequencies for transmission via said transmitter.

12. The system according to claim 11, wherein said processor enables generation of said at least one frequency control word for said at least one DDFS.

13. The system according to claim 11, wherein said at least one DDFS enables generation of said at least one signal with a first frequency value for said down converting of said radio frequency signals received via said receiver.

14. The system according to claim 11, wherein said at least one DDFS enables generation of said at least one signal with a second frequency value for said up converting of signals to said radio frequencies for transmission via said transmitter.

15. The system according to claim 11, wherein said at least one DDFS enables generation of said at least one signal with a same frequency value for said down converting of said radio frequency signals received via said receiver and for said up converting of signals to said radio frequencies for transmission via said transmitter.

16. The system according to claim 11, wherein a first of said at least one DDFS enables generation of said at least one signal for said down converting of said radio frequency signals received via said receiver.

17. The system according to claim 16, wherein said processor enables generation of said at least one frequency control word for said first of said at least one DDFS.

18. The system according to claim 11, wherein a second of said at least one DDFS enables generation of said at least one signal for said up converting of signals to said radio frequencies for transmission via said transmitter.

19. The system according to claim 18, wherein said processor enables generation of said at least one frequency control word for said second of said at least one DDFS.

20. The system according to claim 11, wherein said processor enables adjusting of said at least one frequency control word based on a communication protocol.
